(19) United States
(12) Patent Application Publication
(10) Pub. No.: US 2011/0122319 A1
(43) Pub. Date: May 26, 2011

(54) SYSTEM AND METHOD FOR CONFIGURING A TELEVISION CHANNEL SCAN LIST

(75) Inventors: James Duane Tenbarge, Fishers, IN (US); Bret David Hawkins, Brownsburg, IN (US)

(73) Assignee: Shenzhen TCL New Technology LTD, Shenzhen (CN)

(21) Appl. No.: 12/674,635

(22) PCT Filed: Sep. 28, 2007
(86) PCT No.: PCT/US2007/079930

§ 371 Date: Feb. 22, 2010

(30) Foreign Application Priority Data
Sep. 13, 2007 (CN) 200710077092.3

(51) Int. Cl. H04N 5/50

(52) U.S. Cl. 348/570; 348/E05.097

(57) ABSTRACT

There is provided a system and method for configuring a television scan list. More specifically, in one embodiment, there is provided a method comprising determining whether a channel is potentially objectionable when the channel is selected for display, providing a prompt with an option to remove the channel if the channel is determined to be potentially objectionable, and marking the channel as deleted if the option to remove the channel is selected.

### FIELD OF THE INVENTION

The present invention relates generally to managing television operation, and more particularly to configuring a scan list of television channels.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Digital cable may be defined as a type of cable television distribution using digital video compression. Many cable distributors offer digital cable as a service to consumers. Digital cable utilizes digital technology to facilitate provision of a larger number of channels to consumers than would be available with analog channels alone. Indeed, using video compression and digital channels, cable distributors may increase the number and diversity of programs available on their existing cable networks without requiring network additions.

Typical television systems that are Digital Cable Ready (DCR) are configured to automatically detect available channels and add the channels to a scan list. This may include receiving a channel map of potentially available channels from a cable headend. Once detected, the scan list may be utilized to efficiently navigate available channels. For example, a user may toggle a “channel up” or a “channel down” button on a television controller to cycle through the channels in the scan list and thus display the corresponding content on the television. However, many of the channels automatically included in the scan list may be unavailable or invalid. For example, a particular channel may be a pay-per-view channel, may have a weak signal, may include scrambled content, may not include video/audio content, or may no longer exist. Continually cycling through such channels can be a time burden and an annoyance to users.

Traditional television systems require that a user navigate a series of menus, such as setup menus on a television or profile menus on a setup box, to remove undesirable or invalid channels from the scan list. Much like continually cycling through the invalid channels, navigating a series of menus can also be burdensome and annoying to the user.

### BRIEF DESCRIPTION OF THE DRAWINGS

Advantages of the invention may become apparent upon reading the following detailed description and upon reference to the drawings in which:

FIG. 1 is a block diagram of an electronic device in accordance with an exemplary embodiment of the present invention;

FIG. 2 is a process flow diagram representing cable channel map processing in accordance with an exemplary embodiment of the present invention;

FIG. 3 is a block diagram representing a procedure for configuring a scan list in accordance with exemplary embodiments of the present invention; and

FIG. 4 is a block diagram of a system adapted to configure a scan list in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

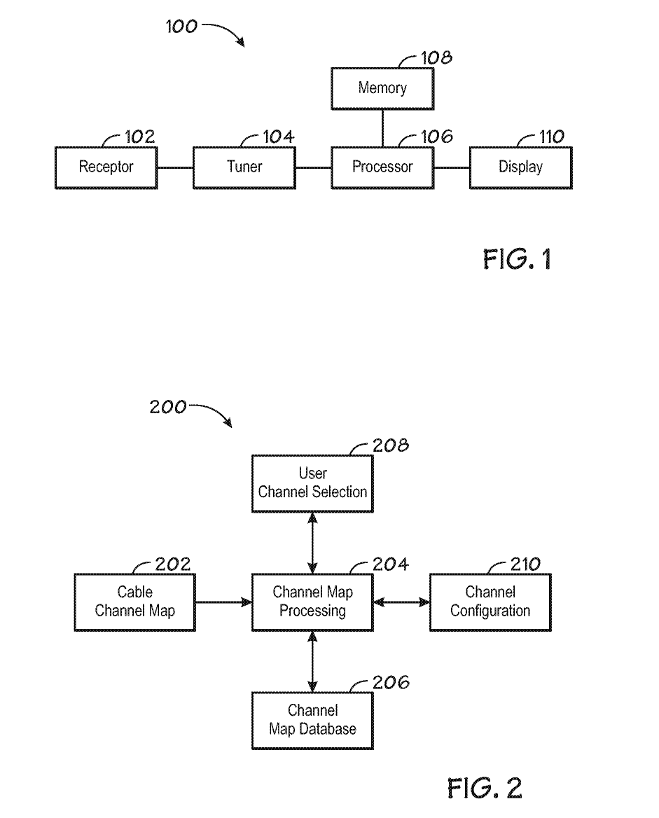

FIG. 1 is a block diagram of an electronic device in accordance with an exemplary embodiment of the present invention. The electronic device (e.g., a television) is generally indicated by reference numeral 100. The electronic device 100 comprises a receptor 102 (e.g., a cable inlet or an antenna), a tuner 104, a processor 106, a memory 108, and a display 110. The memory 108 may be adapted to hold machine-readable computer code that causes the processor 106 to perform an exemplary method in accordance with the present invention. For example, in accordance with present embodiments, the memory 108 may store computer code that causes the processor 106 to prompt a user regarding weak, undesirable or invalid channels and/or remove such channels from a scan list based on input from a user.

Many televisions are configured to perform a channel search operation to identify valid channels when the television is initially set up or when a program source is changed. A channel search operation may identify both analog and digital cable channels that are available to a television, and include the channels in a scan list. Such a search operation generally detects channels that carry a valid program signal and/or channels that are provided in a channel map acquired from a cable headend. If a signal is present during the search operation, the channel may be added or mapped to the scan list (e.g., a channel database stored in non-volatile memory). After the search operation is performed, channels identified as not having valid program signals may be essentially ignored and not shown during typical operation of the television. For example, channels without valid signals may be skipped over when the user presses the “channel up” or “channel down” button on a television controller. However, some search operations may simply acquire all potential channels for the scan list without attempting to discern the validity of any of the channels. For example, a search operation may include simply acquiring a channel map from a cable headend, which typically results in inclusion of invalid channels.

Even when a search operation attempts to validate potentially available channels, a typical search operation inevitably includes a number of channels on the scan list that are invalid or undesirable. For example, a television may detect a channel with a signal that is too weak to support proper viewing of the channel's content. Similarly, a cable headend may provide a channel map to the television, wherein the channel map includes various invalid channels (e.g., channels that are unavailable because the user did not subscribe to the associated programming). Additionally, the search operation may include channels that are undesirable (e.g., a channel with content that is broadcast is a language foreign to the user). Further, a user may establish a scan list based on channels that are available at the time, and those channels may become invalid at a later time. For example, the user may switch cable providers or quit paying for a channel subscription. Accordingly, present embodiments are directed to a system and method for facilitating convenient removal of invalid and/or undesirable channels from the scan list of a television.

FIG. 2 is a block diagram 200 representing processing a channel scan list in accordance with an exemplary embodiment of the present invention. Specifically, FIG. 2 illustrates a cable channel map 202 provided by a cable headend that may be processed in block 204 by a channel map processing unit and added to a channel map database 206 stored in random access memory (RAM), non-volatile memory (NVM) or the like. The channel map database 206 may operate as the scan list for cycling through channels for viewing. In some embodiments, mapping channels and storing them in memory may include searching available channels and mapping those with a sufficiently clear signal (e.g., analog signal) into the channel map database 206.

Block 208 of FIG. 2 represents selection of channels for display by a user. For example, this may include selecting certain channel numbers via a “channel up” or “channel down” button on a television panel or remote control for display of the associated content on a television screen. If the user selects a channel that is invalid (e.g., the channel is unavailable, scrambled, or has a weak signal), the condition of the channel may be detected and the user may be notified and prompted to keep or delete the channel in the scan list. In other words, present embodiments facilitate detection and configuration of undesirable channels in a scan list. For example, as illustrated by block 210, upon detecting Program and System Information Protocol (PSIP) data indicating an invalid channel or upon detecting a signal that is too weak to be properly transmitted, an alert may be initiated in an on-screen display (OSD) that indicates that the channel is invalid. It should be noted that PSIP is merely a representative system. Indeed, present embodiments may apply to all types of digital broadcasts (e.g., DVB, MPEG2 tables, and satellite).

Further, the user may be provided with a selection option (e.g., a virtual button within the OSD) that when selected removes the invalid channel from the scan list or channel map database 206. In some embodiments, a particular button on a television controller (e.g., remote control) may serve this function. Thus, in accordance with present embodiments, a user can readily remove invalid channels from the scan list or channel map database 206 without navigating through a series of setup menus or the like. In some embodiments, the user may initiate the channel correction function for channels that are not automatically detected as undesirable or potentially objectionable.

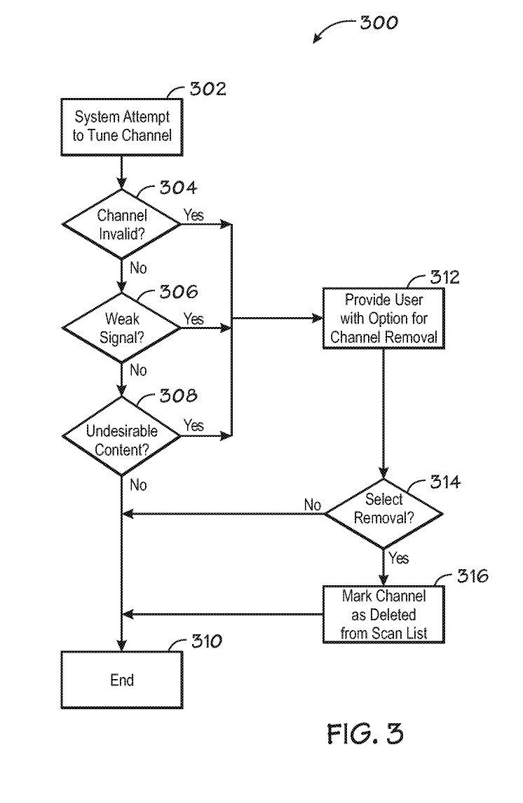

FIG. 3 is a block diagram representing a procedure for detection and removal of undesirable or objectionable channels in accordance with an exemplary embodiment of the present invention. The procedure is generally indicated by reference numeral 300. As illustrated by block 302, the procedure 300 may begin with an attempt to tune a selected channel. For example, a user may change the channel on a television using a “channel up” or “channel down” key on a remote control, which results in the television attempting to tune the selected channel. Next, in blocks 304, 306 and 308, the selected channel is analyzed to determine whether it is potentially objectionable. Determining whether a channel is potentially objectionable may include determining whether the channel is invalid, scrambled, has a weak signal, or is associated with objectionable content. If the channel is not determined to be potentially objectionable, the process ends at block 310. If the channel is found to be potentially objectionable, a user is prompted to remove or keep the selected channel, as illustrated by block 312. Next, the user provides input and the channel is marked as deleted or maintained as a valid channel based on the user's input, as illustrated by blocks 314 and 316.

Specifically, determining whether the selected channel is potentially objectionable may include determining a status of the channel, a level of signal strength associated with the channel and/or content associated with the channel. Indeed, in the illustrated embodiment of FIG. 3, block 304 represents determining whether the selected channel is invalid (e.g., scrambled). For example, an invalid channel may be detected by reading PSIP data for the channel, which may directly indicate that the channel is invalid. If the channel is not invalid, a determination of whether the signal for the channel is weak may be made, as illustrated in block 306. For example, a measure of the channel signal's strength may be compared to a threshold value, and the channel may be considered potentially objectionable because it is too weak if the threshold is not exceeded. This threshold value may be defined or input by a user. Further, in some embodiments, other data (e.g., broadcast language, adult ratings) associated with the channel may be detected to determine whether the channel is potentially objectionable, as illustrated by block 308. The determination of whether the selected channel is potentially objectionable in block 308 may be based on settings or preferences supplied by the user. For example, a user may specify that channels with adult content are potentially objectionable. If the channel is not invalid, not weak, and does not include other undesirable features, the procedure 300 may end, as illustrated by block 310, without prompting the user regarding removal or deletion of the selected channel. In one exemplary embodiment, one or more of the functions represented by blocks 304, 306 and 308 is not performed at all.

If the channel is found to be invalid in block 304, the channel's signal is found to be too weak in block 306, or other undesirable characteristics are found to be associated with the channel in block 308, the procedure 300 may proceed to prompt the user to determine whether the channel should be removed. Specifically, as illustrated by block 312, an on-screen display (OSD) may be activated with an option for the user to remove the channel from the scan list. In block 314, a determination may be made as to whether the user selected to keep the channel or remove the channel. If the user selected to keep the channel in the scan list in block 314, the procedure 300 continues to block 310 and ends. In some embodiments, selecting to keep the channel may result in a modification of the scan list to ignore the potentially objectionable nature of the channel when selected. If the user selected to remove the channel in block 314, the procedure continues to block 316, wherein the channel is marked as deleted from the scan list. Once the channel is marked as deleted from the scan list, it may only be accessible by direct-digit entry or added to the scan list through a menu option. In some embodiments, a lock (e.g., a password enabled security feature) may be placed on channels marked as deleted such that even direct entry does not activate viewing of the channel. Once the channel has been marked as deleted, the procedure 300 continues to the end at block 310.

It should be noted that in some embodiments, the order associated with blocks 304, 306 and 308 may be different. For example, it may be desirable to determine whether the selected channel has a weak signal (block 306) before determining whether it is valid (block 304). However, it may be desirable to detect whether a channel is invalid (block 304) first to facilitate efficient evaluation of whether the channel is potentially objectionable. For example, if the channel is confirmed to be invalid, it may not be necessary to determine whether the content associated with the channel is potentially objectionable, which may save evaluation time.

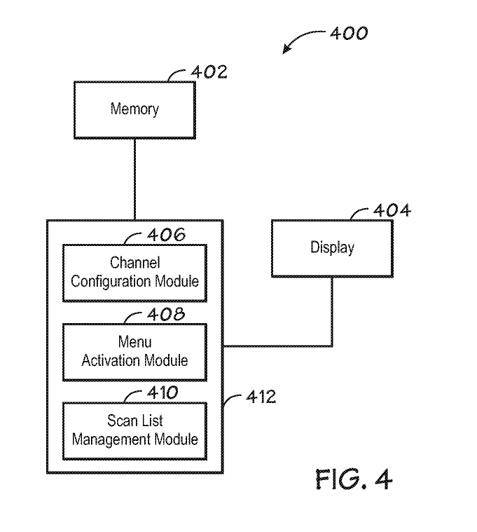

FIG. 4 is a block diagram of a system adapted to configure a scan list in accordance with an exemplary embodiment of the present invention. The system is generally indicated by reference numeral 400. The system 400 comprises a memory 402, a display 404, a channel configuration module 406, a menu activation module 408, and a scan list management module 410. These features of the system 400 may include software and/or hardware components. Further, the channel configuration module 406, the menu activation module 408, and the scan list management module 410 may collectively be included in a scan list management package 412. The system may operate in accordance with the process illustrated in FIG. 3.

The channel configuration module 406 may be configured to determine whether a channel is potentially objectionable when the channel is selected for presentation on the display 404. For example, the channel configuration module 406 may be configured to determine whether the channel is invalid, has a weak signal, includes undesirable content, and the like. The menu activation module 408 may be configured to prompt a user to input whether to remove the channel from a scan list stored in the memory 402, if the channel is determined to be potentially objectionable. Further, the menu activation module 408 may be configured to provide an on-screen display for presentation on the display 404. The scan list management module 410 may be configured to limit access to the channel if the input indicates the channel should be removed.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method comprising:
determining whether a channel is potentially objectionable when the channel is selected for display;
providing a prompt with an option to remove the channel if the channel is determined to be potentially objectionable; and
marking the channel as deleted if the option to remove the channel is selected.

2. The method of claim 1, comprising determining whether the channel is potentially objectionable because it is invalid.

3. The method of claim 1, comprising determining whether the channel is potentially objectionable because it is scrambled.

4. The method of claim 1, comprising determining whether the channel is potentially objectionable because it has a weak signal.

5. The method of claim 1, comprising measuring a signal strength of a signal of the channel and comparing the measure of the signal strength with a user-defined threshold that is indicative of whether the signal is weak.

6. The method of claim 1, comprising determining whether the channel is potentially objectionable because it is associated with objectionable content.

7. The method of claim 6, comprising selecting criteria that define whether content associated with the channel is objectionable.

8. The method of claim 1, comprising indicating that the channel is valid if the option to remove the channel is not selected.

9. The method of claim 1, comprising selecting the channel when a channel up or channel down selection is detected.

10. A method comprising:
receiving a channel scan list;
attempting to tune a selected channel;
determining whether the selected channel is potentially objectionable;
providing an on-screen display with a option to remove the selected channel from the scan list if the selected channel is determined to be potentially objectionable; and
reducing access to the selected channel if the option to remove the selected channel is selected.

11. The method of claim 10, determining whether the channel is potentially objectionable because it is associated with undesirable content.

12. The method of claim 10, comprising determining whether the channel is potentially objectionable because it has a weak signal.

13. The method of claim 10, comprising determining whether the channel potentially objectionable because it is invalid.

14. The method of claim 13, comprising determining whether the channel is potentially objectionable because it has a weak signal if the channel is not invalid.

15. The method of claim 13, comprising determining whether the channel potentially objectionable because it is associated with undesirable content if the channel is not invalid.

16. A system comprising:
a memory;
a display;
a channel configuration module configured to determine whether a channel is potentially objectionable when the channel is selected for presentation on the display;
a menu activation module configured to prompt a user to input whether to remove the channel from a scan list stored in the memory if the channel is determined to be potentially objectionable; and
a scan list management module configured to limit access to the channel if the input indicates the channel should be removed.

17. The system of claim 16, wherein the channel configuration module is configured to determine that a channel is potentially objectionable if the channel configuration module determines that the channel is invalid.

18. The system of claim 16, wherein the channel configuration module is configured to determine that a channel is potentially objectionable if the channel configuration module determines that the channel has a weak signal.

19. The system of claim 16, wherein the channel configuration module is configured to determine that a channel is potentially objectionable if the channel configuration module determines that the channel is associated with undesirable content.

20. The method of claim 16, wherein the menu activation module is configured to provide an on-screen display for presentation on the display.
